(19) United States
(12) Patent Application Publication
(10) Pub. No.: US 2006/0133357 A1
(43) Pub. Date: Jun. 22, 2006

(54) Method for positioning information service, internet protocol network system for providing the same, and mobile communication terminal and method for receiving the same

(75) Inventor: Seung-Bum Lee, Suwon-si (KR)

Correspondence Address: DILWORTH & BARRESE, LLP, 333 EARLE OVINGTON BLVD., UNIONDALE, NY, 11553, US

(73) Assignee: Samsung Electronics, Co., Ltd.

(21) Appl. No.: 11/303,112

(22) Filed: Dec. 16, 2005

(30) Foreign Application Priority Data
Dec. 17, 2004 (KR) 2004-107846

(51) Int. Cl. H04L 12/66

(52) U.S. Cl. 370/352

(57) ABSTRACT

Disclosed is a mobile communication terminal and method for receiving a positioning information service, and an Internet protocol network system and method for providing the same. The Internet protocol network system for providing mobility service includes a router for periodically broadcasting an advertisement message which includes positioning information and a mobile communication terminal for receiving the advertisement message, reading the positioning information, and determining a position of the mobile communication terminal based on the read positioning information. The method for providing mobility service in an Internet protocol network includes periodically broadcasting an advertisement message by a router, receiving the advertisement message by a mobile communication terminal and reading positioning information from the received advertisement message and recognizing a position of the mobile communication terminal based on the read positioning information, by the mobile communication terminal.

### PRIORITY

This application claims priority under 35 U.S.C. §119(a) to an application entitled “Method For Positioning Information Service, Internet Protocol Network System For Providing The Same, And Mobile Communication Terminal And Method For Receiving The Same” filed in the Korean Intellectual Property Office on Dec. 17, 2004 and assigned Serial No. 2004-107846, the contents of which are incorporated herein by reference.

### BACKGROUND OF THE INVENTION

1. Field of the Invention

The present invention relates to an Internet protocol (IP) network system in which mobility is secured, and more particularly to a method and Internet protocol network system for providing a positioning information service, and a mobile communication terminal and method for receiving the same.

2. Description of the Related Art

Typically, positioning services are provided to mobile communication terminals by a Global Positioning System (GPS), a Code Division Multiple Access (CDMA) network, or the like.

A mobile communication terminal, on which a GPS receiver is mounted, can track its current position using position information (e.g., time and distance from a corresponding GPS satellite) transmitted from at least a plurality of GPS satellites.

In a similar fashion, using the CDMA network, a mobile communication terminal can determine its current position by measuring the distance between itself and each of a plurality of base stations and uses a triangulation method to determine its position.

Recently, mobile communication terminals have begun interworking with network routers using an Internet protocol. An Internet protocol is a basic protocol for Internet technology such as the World Wide Web. A protocol version used most generally is Internet protocol version 4 (IPv4), which has many limitations. Two major limitations of IPv4 are its lack of Internet protocol addresses and its inability to provide mobility. Accordingly; in order to solve these problems, various techniques such as a network address translation (NAT) technique have been employed. Moreover, a new version protocol known as Internet protocol version 6 (IPv6) which provides Internet Protocol addresses and mobility has been proposed. IPv6 is known as the next-generation Internet protocol.

According to these Internet protocols (i.e., IPv4 and IPv6), data is transmitted using a packet transmission scheme. The packet represents data to be transmitted from a node to another node. A source address and a destination address are inserted in the data and routers relay the data by using the destination address, thereby transmitting the data to the destination node. Moreover, IPv4 and IPv6 systems which support mobility include a mobile Internet protocol.

Accordingly, there is a need for a system for providing location information to a mobile communication terminal, and a method thereof.

However, in order for a mobile communication terminal to use the positioning information service provided by the GPS satellites or the CDMA network, the mobile communication terminal requires additional hardware. For example, in order to use the GPS, a mobile communication terminal requires a GPS receiver and a software module thereof.

### SUMMARY OF THE INVENTION

Accordingly, the present invention has been made to solve the above-mentioned problems occurring in the prior art, and the present invention provides a method and an Internet protocol network system for providing a positioning information service without requiring additional hardware of a mobile communication terminal, and the mobile communication terminal and a method for receiving the same.

In accordance with a first aspect of the present invention in order to accomplish the above objects, there is provided an Internet protocol network system for providing a mobility service, the Internet protocol network system including a router for periodically broadcasting an advertisement message which includes positioning information and a mobile communication terminal for receiving the advertisement message, reading the positioning information and determining a position of the mobile communication terminal based on the read positioning information.

In accordance with a second aspect of the present invention, there is provided a method for providing mobility service in an Internet protocol network, the method including periodically broadcasting an advertisement message by using a router receiving the advertisement message by a mobile communication terminal reading positioning information from the received advertisement message and determining a position of the mobile communication terminal based on the read positioning information, by the mobile communication terminal.

n accordance with a third aspect of the present invention, there is provided a mobile communication terminal including a reception unit for periodically receiving an advertisement message from a router of an Internet protocol network and a control unit for reading positioning information from a received advertisement message when the advertisement message is received and determining a position of the mobile communication terminal based on the read positioning information.

In accordance with a second aspect of the present invention, there is provided a method for receiving a positioning information service by a mobile communication terminal in an Internet protocol network, the method including determining whether a new advertisement message is received from a router, and reading positioning information from the received advertisement message and recognizing a position of the mobile communication terminal based on the read positioning information, if it is determined that a new advertisement message has been received.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an Internet protocol network system in which mobility is secured according to an embodiment of the present invention;

FIG. 2 is a diagram illustrating a software configuration of a router employed in the present invention;

FIG. 3 is a diagram illustrating a configuration of an advertisement message of an IPv6 router according to an embodiment of the present invention;

FIG. 4 is a diagram illustrating a software configuration of a mobile communication terminal according to an embodiment of the present invention; and

FIG. 5 is a flowchart illustrating a method for receiving a positioning information service in a mobile communication terminal according to an embodiment of the present invention.

### DETAILED DESCRIPTION OF THE PREFERRED EMBODIMENT

Hereinafter, a preferred embodiment according to the present invention will be described with reference to the accompanying drawings. In the description, detailed Internet protocol versions such as IPv4 (Internet protocol Version 4) and IPv6 (Internet protocol Version 6) and many particular items such as option field types are shown, but these are provided for aiding the general understanding of the present invention, it will be understood by those skilled in the art that the present invention can be embodied without these particular items. In the following description of the embodiments of the present invention, a detailed description of known functions and configurations incorporated herein will be omitted when it may obscure the subject matter of the present invention.

According to an embodiment of the present invention, a mobile communication terminal 300 receives positioning information from a router (e.g., routers 100 and 200) providing service to the mobile communication terminal. Accordingly, the mobile communication terminal is provided with a positioning information service from the router. That is, the mobile communication terminal uses the position of a router currently providing service to the mobile communication terminal, as the position of the mobile communication terminal.

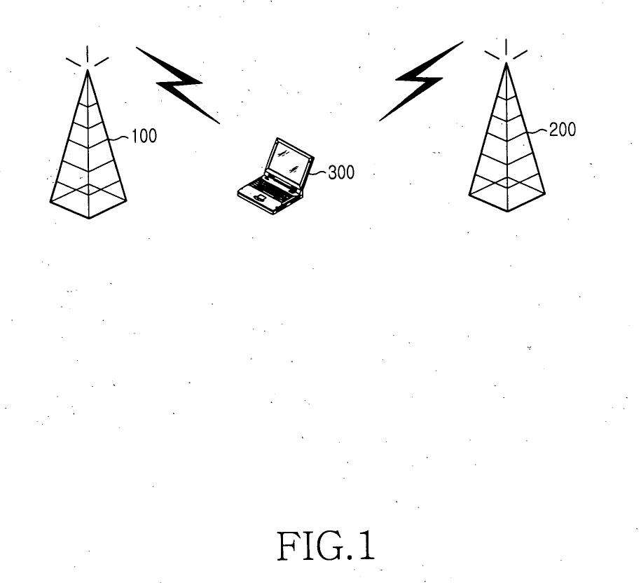

FIG. 1 is a block diagram illustrating an Internet protocol network system in which mobility is secured according to an embodiment of the present invention.

The representative Internet protocol network systems, in which the mobility is secured, include IPv4 and IPv6 having a mobile Internet protocol Reference numerals 100 and 200 represent routers, and reference numeral 300 represents a mobile communication terminal.

When the mobile communication terminal 300, which is also known as a mobile node (MN), having received service from the router 100 moves to change its position and thus receives service from the router 200 belonging to a different network, the mobile communication terminal 300 must notify a correspondent node (CN—not shown) of the position of the mobile communication terminal 300 through a registration procedure.

According to an embodiment of the present invention, before performing such a registration procedure, the mobile communication terminal 300 can acquire its own position information without performing a position measurement therefor. That is, the mobile communication terminal 300 uses positioning information provided by the router 200 as the positioning information of the mobile communication terminal 300 itself. In other words, the mobile communication terminal 300 determines its own position to be equal to that of the router 200, thereby acquiring its own positioning information. To this end, the mobile communication terminal 300 must be equipped with a reception unit and a control unit (both of which are not shown). The reception unit periodically receives an advertisement message from a router of an Internet protocol network. Upon receiving an advertisement message, the control unit reads positioning information from the advertisement message, and recognizes the position of the mobile communication terminal based on the positioning information.

Typically, once a router is set up, it does not change its own position. Therefore, it is possible to transmit positioning information to the mobile communication terminal, by measuring the precise position of a router when the router is set up and recording the measured position in the router.

Although the embodiment of the present invention is described with respect to a case of acquiring positioning information before a registration procedure is performed, in alternative embodiments, the positioning information may be acquired at a variety of different time points. That is, the mobile communication terminal can acquire the positioning information of the router at any time when the mobile communication terminal can receive the positioning information transmitted from the router.

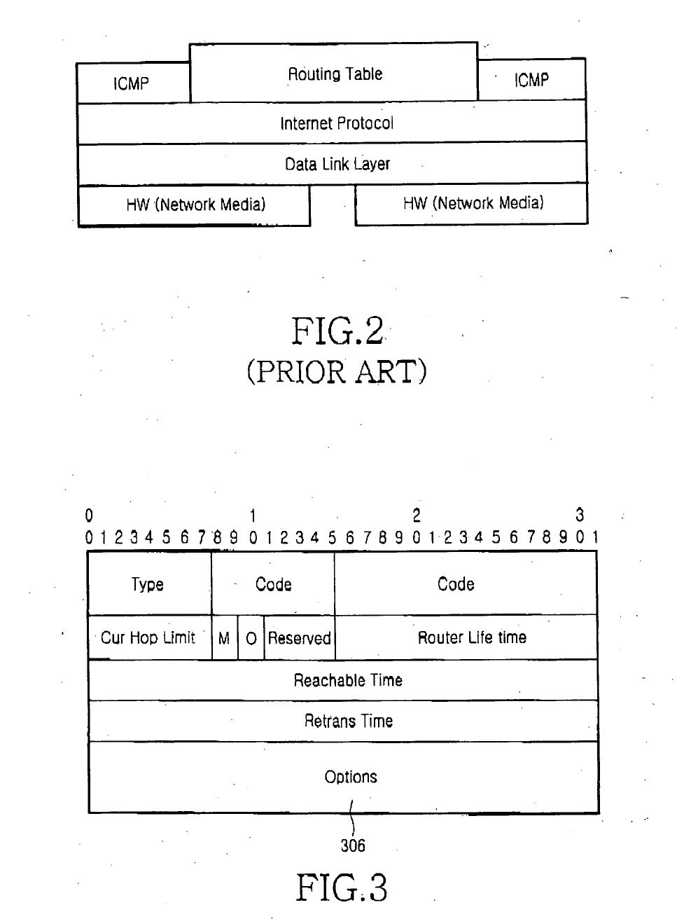

FIG. 2 is a diagram illustrating a software configuration of a router employed in the present invention.

The configuration shown in FIG. 2 is well known in the art and it is unnecessary to change the software configuration of a router in order to realize the present invention.

FIG. 3 is a diagram illustrating a configuration of an advertisement message of an IPv6 router according to an embodiment of the present invention.

The advertisement message having the configuration shown in FIG. 3 is periodically transmitted from the router. The advertisement message includes an option field 306 in which positioning information is added to achieve the present invention. The option filed is configured in a type-length-value (TLV) format.

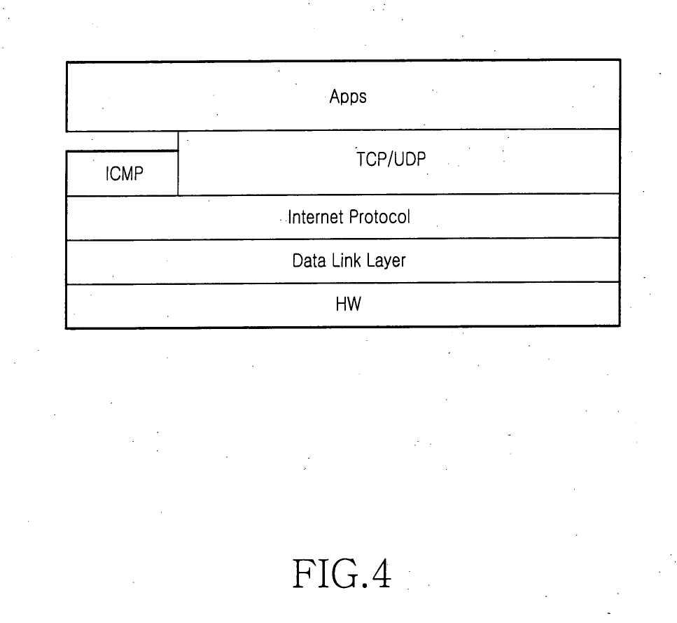

FIG. 4 is a diagram illustrating a software configuration of a mobile communication terminal according to an embodiment of the present invention. The software of the mobile communication terminal 300 includes a function for determining a positioning option from the option field 306 and acquiring positioning information when processing an advertisement message transmitted from a router.

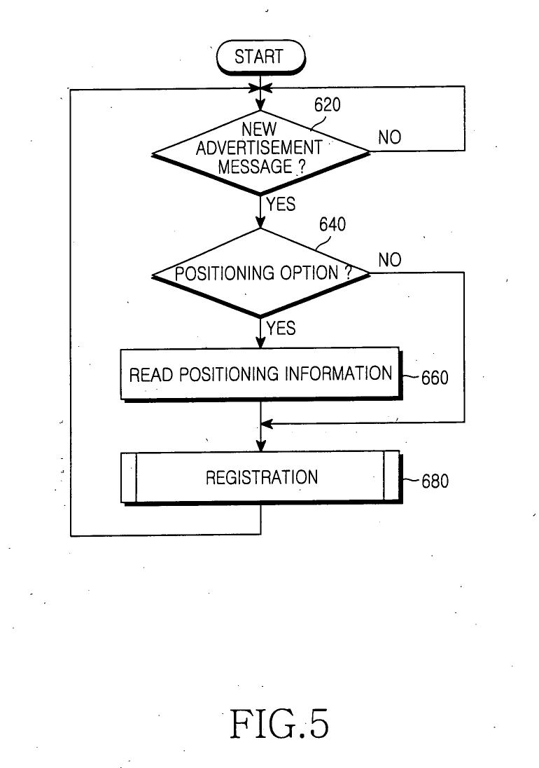

FIG. 5 is a flowchart illustrating a method for receiving the positioning information service by a mobile communication terminal according to an embodiment of the present invention.

In step 620, the mobile communication terminal 300 determines whether the mobile communication terminal has received a new advertisement message from a router. As a result of the determination, when the mobile communication terminal has received a new advertisement message, the mobile communication terminal 300 determines whether the received advertisement message includes a positioning option in step 640. As described above with reference to FIG. 3, an advertisement message option field may include a plurality of options. Therefore, the advertisement message may discretely include information representing the existence of each option to allow the mobile communication terminal 300 to first check whether a desired option exists. If a desired option exists, the mobile communication terminal 300 reads information of a corresponding option.

When the mobile communication terminal 300 determines that the received advertisement message includes a positioning option in step 640, the mobile communication terminal 300 reads a positioning message from the received advertisement message in step 660 and uses the read positioning message to acquire its position. Until the mobile communication terminal 300 changes location after the confirmation of its own position, the mobile communication terminal 300 can use position information acquired in step 660 when information about its position is required.

The mobile communication terminal 300 then performs a registration procedure in step 680. Herein, it is not necessarily to perform the registration procedure (i.e., in the step 680) when the mobile communication terminal 300 acquires information about its own position. However, the mobile communication terminal 300 does not have to acquire information about its position before performing the registration procedure.

According to another embodiment of the present invention, when the power supply of a mobile communication terminal is powered on, it is possible to determine if a time zone of a user has changed by checking user' movement and to show the display time of the mobile communication terminal by automatically adjusting the display time.

According to still another embodiment of the present invention, it is also possible to provide users with services such as displaying sale information, coupon information or special event information of stores located in the vicinity of the mobile communication terminal according to the position of the mobile communication terminal if the users have set a corresponding service item in the mobile communication terminal.

As described above, according to the embodiments of the present invention, a positioning information service can be provided at a low cost. That is, according to the embodiments of the present invention, since the position of a mobile communication terminal is estimated by the position of a corresponding router, the present invention can be utilized for providing services, such as an automatic standard time setting service or a peripheral geographical information service, which does not require a high precision, at a low cost.

While the present invention has been shown and described with reference to certain preferred embodiments thereof, it will be understood by those skilled in the art that various changes in form and detail may be made therein without departing from the spirit and scope of the invention as defined by the appended claims. Accordingly, the scope of the invention is not to be limited by the above embodiments but by the claims and the equivalents thereof.

What is claimed is:

1. An Internet protocol network system for providing mobility service, the Internet protocol network system comprising:
a router for periodically broadcasting an advertisement message which includes positioning information; and
a mobile communication terminal for receiving the advertisement message, reading the positioning information, and determining a position of the mobile communication terminal based on the read positioning information.

2. The Internet protocol network system as claimed in claim 1, wherein the advertisement message includes an option field, and the router inserts a positioning option into the option field and broadcasts the advertisement message.

3. The Internet protocol network system as claimed in claim 2, wherein when the mobile communication terminal receives another advertisement message, the mobile communication terminal:
determines whether a positioning option is included in the another advertisement message; and
reads positioning information, when it is determined that the positioning option is included in the another advertisement message.

4. A method for providing mobility service in an Internet protocol network, the method comprising the steps of:
periodically broadcasting an advertisement message, by a router;
receiving the advertisement message, by a mobile communication terminal; and
reading positioning information from the received advertisement message and recognizing a position of the mobile communication terminal based on the read positioning information, by the mobile communication terminal.

5. The method as claimed in claim 4, further comprising:
determining whether a positioning option is included in the received advertisement message, by the mobile communication terminal; and
reading the positioning information when it is determined that the positioning option is included in the received advertisement message, by the mobile communication terminal.

6. The method as claimed in claim 4, further comprising:
determining a change of current router to another router, to which the mobile communication terminal is connected; and
updating position information of the mobile communication terminal using positioning information provided by the another router.

7. The method as claimed in claim 6, further comprising registering the mobile communication terminal with the another router.

8. A mobile communication terminal comprising:
a reception unit for periodically receiving an advertisement message from a router of an Internet protocol network; and
a control unit for: reading positioning information from a received advertisement message when the advertisement message is received: and
determining a position of the mobile communication terminal based on the read positioning information.

9. The mobile communication terminal as claimed in claim 8, wherein, the control unit determines whether a positioning option is included in the received advertisement message, and reads positioning information when it is determined that the positioning option is included in the received advertisement message.

10. A method for receiving a positioning information service by a mobile communication terminal in an Internet protocol network, the method comprising the steps of:
determining whether another advertisement message is received from a router;
reading positioning information from the received advertisement message if it is determined that the another advertisement message is received from the router, and
determining a position of the mobile communication terminal based on the read positioning information.

11. The method as claimed in claim 10, further comprising: determining, by the mobile communication terminal, whether a positioning option is included in the another advertisement message; and
reading, by the mobile communication terminal, the positioning information, if it is determined that the positioning information is included in the another advertisement message.

12. The method as claimed in claim 10, further comprising
determining a change of current router to another router to which the mobile communication terminal is connected; and
updating position information of the mobile communication terminal using positioning information provided by the another router.

13. The method as claimed in claim 12, further comprising registering the mobile station terminal with the another router.
